(19) United States
(12) Patent Application Publication
(10) Pub. No.: US 2025/0289152 A1
(43) Pub. Date: Sep. 18, 2025

(54) MAGNETIC LOCK WITH THROWABLE ROBOT

(71) Applicant: ReconRobotics, Inc., Edina, MN (US)

(72) Inventors: Alex J. Kossett, Minnetonka, MN (US); Andrew Drenner, Savage, MN (US)

(21) Appl. No.: 19/226,386

(22) Filed: Jun. 3, 2025

Related U.S. Application Data
(63) Continuation-in-part of application No. 18/380,143, filed on Oct. 13, 2023, now Pat. No. 12,318,922.
Application No. 18/380,143 is a continuation of application No. 17/241,816, filed on Apr. 27, 2021, now abandoned.
Application No. 17/241,816 is a continuation of application No. 15/998,672, filed on Aug. 15, 2018, now Pat. No. 10,987,818.
(60) Provisional application No. 62/545,914, filed on Aug. 15, 2017.
(60) Provisional application No. 63/704,925, filed on Oct. 8, 2024.

(51) Int. Cl. B25J 19/02; B25J 5/00; B60K 1/02; B60R 16/023; B62D 57/02; F41H 7/00; G07C 9/00

(52) U.S. Cl. CPC B25J 19/027; B25J 5/007; B25J 19/023; B60R 16/0231; B62D 57/02; F41H 7/005; G07C 9/00174; G07C 9/00896; B60K 1/02; B60Y 2200/24

(57) ABSTRACT

A two wheeled throwable robot comprises an elongate chassis with two ends, a motor at each end, drive wheels connected to the motors, and a tail extending from the elongate chassis. The throwable robot includes an enable/disable arrangement comprising a pair of magnets generating a magnetic field and a magnetic field sensor positioned in proximity to the pair of magnets. The sensor is activated upon the occurrence of a specific modification of the magnetic field. The throwable robot may include a key member formed of a material to modify the magnetic field to enable the robot.

### CROSS-REFERENCE TO RELATED APPLICATIONS

This application is a continuation-in-part of U.S. patent application Ser. No. 18/380,143, filed Oct. 13, 2023, now U.S. Pat. No. 12,318,922, issued Jun. 3, 2025, which is a continuation of U.S. patent application Ser. No. 17/241,816, filed Apr. 27, 2021, which is a continuation of U.S. patent application Ser. No. 15/998,672, filed Aug. 15, 2018, now U.S. Pat. No. 10,987,818, issued Apr. 27, 2021, which claims the benefit of U.S. Provisional Application No. 62/545,914, filed Aug. 15, 2017. This application also claims priority to U.S. Provisional Application No. 63/704,925, filed Oct. 8, 2024. The contents of which are incorporated by reference herein in their entireties.

### BACKGROUND OF THE INVENTION

Throwable robots used in military and policing operations need to be robust and able to survive exposure to rugged conditions including water and vertical drops. Robots used in hostile military and policing operations require robust, reliable, and secure control systems, including enable-disable switches. Improvements in reliability and performance for robots used in high stakes military and police operations are desirable.

### SUMMARY OF THE INVENTION

This invention relates to a means to readily, reliably, and securely enable or disable a device, for example a throwable robot. In one example, to detect the presence of a ferromagnetic component, in a tamper-resistant and environmentally-sealed manner. In embodiments, the throwable surveillance robot comprises a pair of axially aligned drive wheels, each wheel having a maximum diameter. The surveillance robot may have a body comprising a housing extending between the drive wheels. In embodiments, the housing is disposed completely within a cylinder defined by the maximum diameters of the drive wheels. In embodiments, the housing defines a housing cavity containing a receiver, a transmitter, and a video camera connected to the transmitter. The housing may include a key holding portion defining a key holding slot having a key member insertion and withdrawal axis. In embodiments, throwing of the surveillance robot is facilitated by a design providing a total weight of less than six pounds.

In embodiments, the surveillance robot comprises a first magnet and a second magnet disposed inside the housing cavity. The magnets may provide a magnetic flux field. Each magnet may be located near the key holding slot with a wall portion of the housing extending between each magnet and the key holding slot. The surveillance robot may also comprise a key member conforming to the key holding slot. In embodiments, the key member comprises a material with a relative electromagnetic permeability greater than five hundred so that the magnetic flux field produced by the magnets changes when the key member is disposed in the key holding slot. In embodiments, the magnets produce a first, undeformed magnetic field while the key member is disposed in the key holding slot and the magnets produce a second, deformed magnetic field while the key member is not disposed in the key holding slot.

In embodiments, the surveillance robot comprises a magnetic field sensor disposed inside the housing cavity. The magnetic field sensor may be, for example, positioned between the first magnet and the second magnet. In embodiments, the magnetic field sensor provides a first output signal when the first, undeformed magnetic field is present and a second output signal when the second, deformed magnetic field is present. In some embodiments, the first output signal is a logical one and the second output signal is a logical zero. In other embodiments, the first output signal is a logical zero and the second output signal is a logical one. In embodiments, the housing includes a wall portion separating the key holding slot from the housing cavity. In embodiments, each magnet is located near the key holding slot with the wall portion of the housing extending between each magnet and the key holding slot.

The magnetic field sensor may comprise, for example, a Hall effect sensor. In embodiments, the presence of the key member in the key holding slot defined by the key holding portion alters a magnitude of the magnetic field produced by the magnets at the magnetic field sensor. For example, the magnetic field produced by the magnets may have a first magnitude at the magnetic field sensor while the key member is present in the key holding slot and a second magnitude at the magnetic field sensor while the key member is absent from the key holding slot.

In embodiments, the presence of the key member in the key holding slot defined by the key holding portion alters an angle of flux lines in the magnetic field produced by the magnets at the magnetic field sensor. For example, the flux lines in the magnetic field produced by the magnets may have a first angle at the magnetic field sensor while the key member is present in the key holding slot and a second angle at the magnetic field sensor while the key member is absent from the key holding slot.

The above summary is not intended to describe each illustrated embodiment or every implementation of the present disclosure.

### DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a top, front, left perspective view of a throwable robot in accordance with the detailed description.

FIG. 2 is a partially exploded perspective view showing a key member and a throwable robot that is activated and/or deactivated using the key member.

FIG. 3 is a perspective view showing a portion of a throwable robot. In the embodiment of FIG. 3, the wheels have been removed for purposes of illustration.

FIG. 4 is an enlarged view showing a portion of the throwable robot shown in FIG. 3.

FIG. 5 is an additional view showing the portion of the throwable robot shown in FIG. 4. In the embodiment of FIG. 5, a portion of the throwable robot has been removed. A key member, a key receiving slot, and a key retaining mechanism are visible in FIG. 5.

FIG. 6A and FIG. 6B are perspective views showing a key member and a portion of a throwable robot. In FIG. 6A, an arrow is used to illustrate the insertion motion of the key member. In the embodiment of FIG. 6B, the key member is shown residing in an inserted position.

FIG. 7 is a diagrammatic front view showing a key member and a portion of a throwable robot that is activated and/or deactivated using the key member.

FIG. 8 a is stylized cross-sectional view showing a key member and a portion of a throwable robot that is activated and/or deactivated using the key member.

FIG. 9A is a diagram showing two magnets and lines of magnetic flux in a magnetic field produced by the two magnets.

FIG. 9B is a diagram showing two magnets and lines of magnetic flux in a magnetic field produced by the two magnets.

FIG. 10A is a diagram showing two magnets and lines of magnetic flux in a magnetic field produced by the two magnets. The path taken by the lines of magnetic flux is influenced by a key member in the embodiment of FIG. 10A.

FIG. 10B is a diagram showing two magnets and lines of magnetic flux in a magnetic field produced by the two magnets. The path taken by the lines of magnetic flux is influenced by a key member in the embodiment of FIG. 10B.

FIG. 11 is a diagram showing two magnets and lines of magnetic flux in a magnetic field produced by the two magnets. The path taken by the lines of magnetic flux is influenced by a key member in the embodiment of FIG. 11.

FIG. 12A is a perspective view of a circuit card assembly including a printed wiring board and a Hall effect sensor.

FIG. 12B is a top plan view of a circuit card assembly including a printed wiring board and a Hall effect sensor.

FIG. 13A is a view of a drone carrying a robot.

FIG. 13B depicts the drone of FIG. 13A dropping the robot above a deployment site.

FIG. 13C depicts the drone of FIG. 13A at a deployment site.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

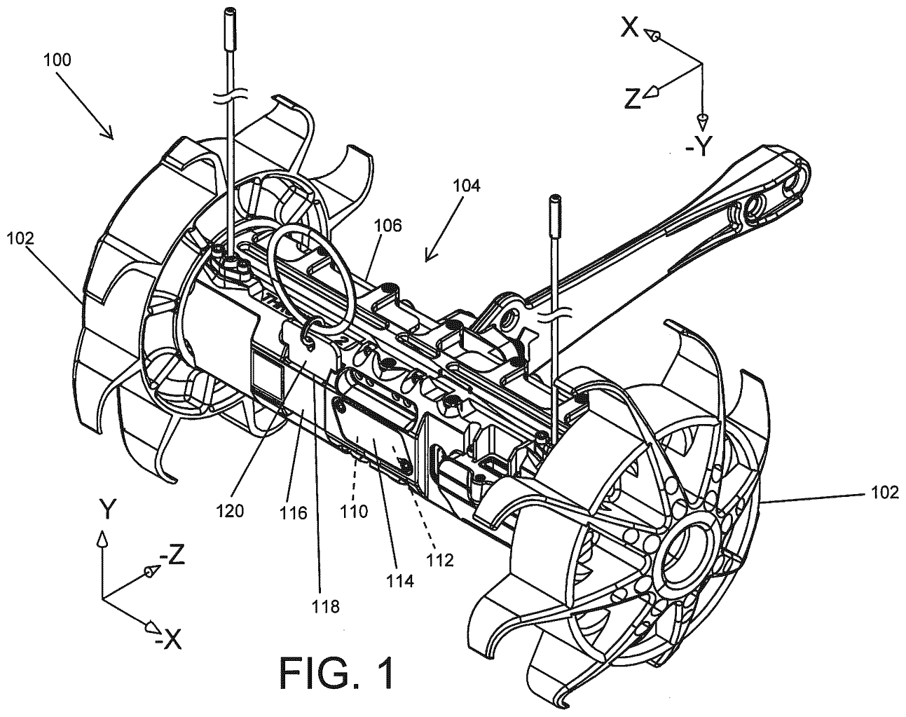

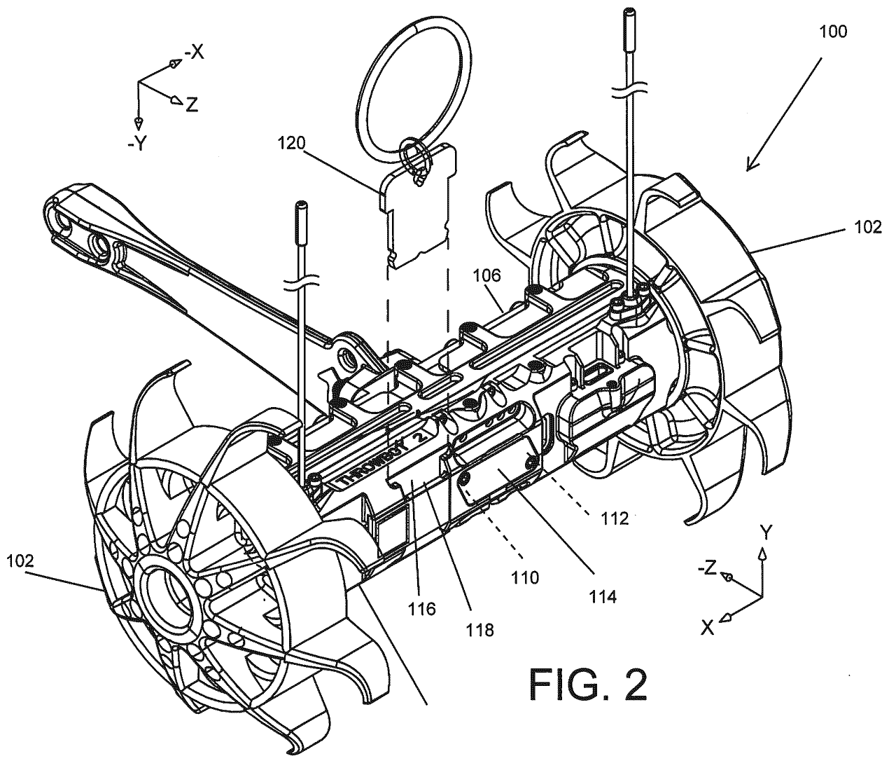

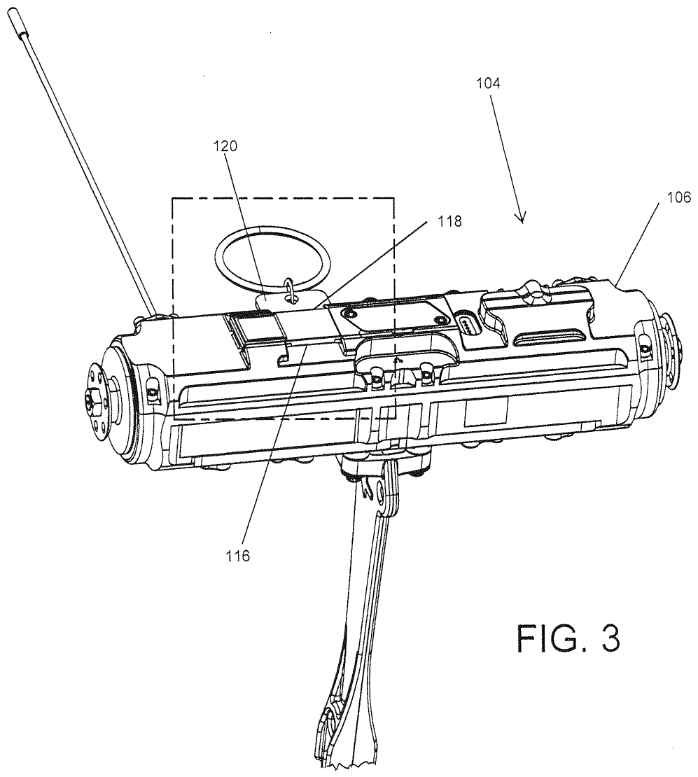

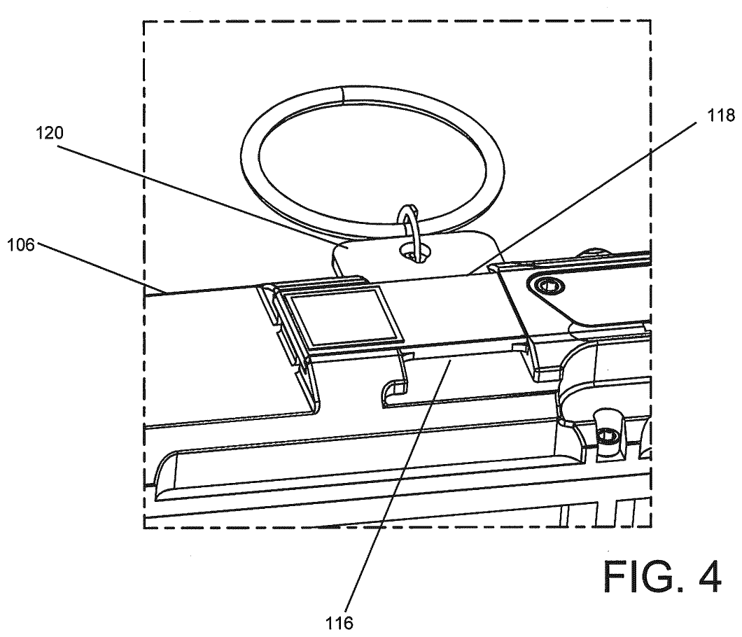

Referring to FIGS. 1 and 2, in embodiments, a throwable surveillance robot 100 comprises a pair of axially aligned drive wheels 102, each wheel 102 having a maximum diameter. The surveillance robot 100 may have a body 104 comprising a housing 106 extending between the drive wheels 102. In embodiments, the housing 106 is disposed completely within a cylinder defined by the maximum diameters of the drive wheels 102. In embodiments, the housing 106 defines a housing cavity 108 containing a receiver 110, a transmitter 112, and a video camera 114 connected to the transmitter 112. The housing 106 may include a key holding portion 116 defining a key holding slot 118 having a key member insertion and withdrawal axis. In embodiments, throwing of the surveillance robot 100 is facilitated by a design providing a total weight of less than six pounds.

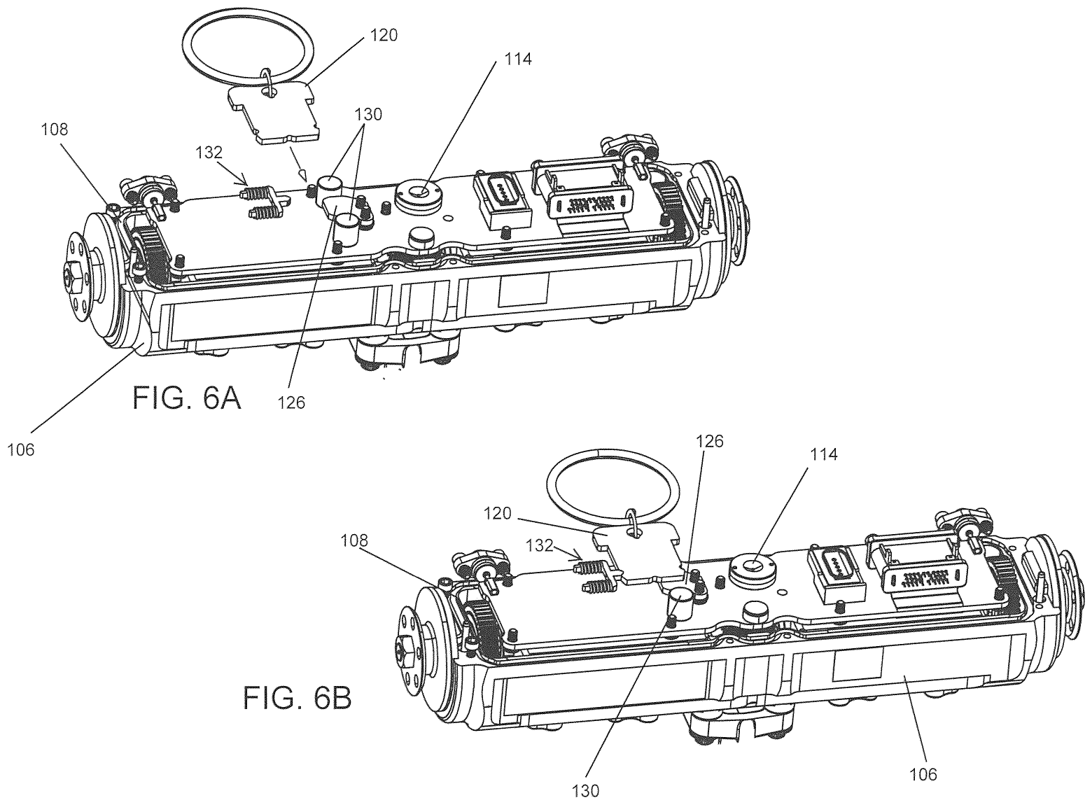

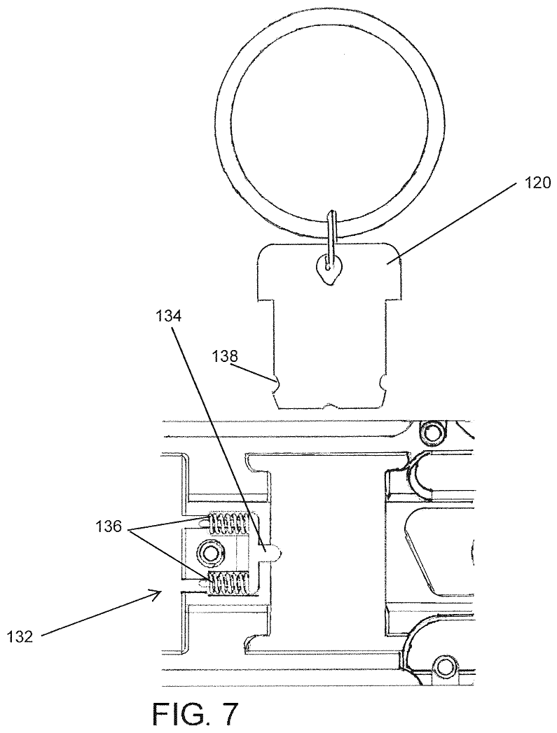

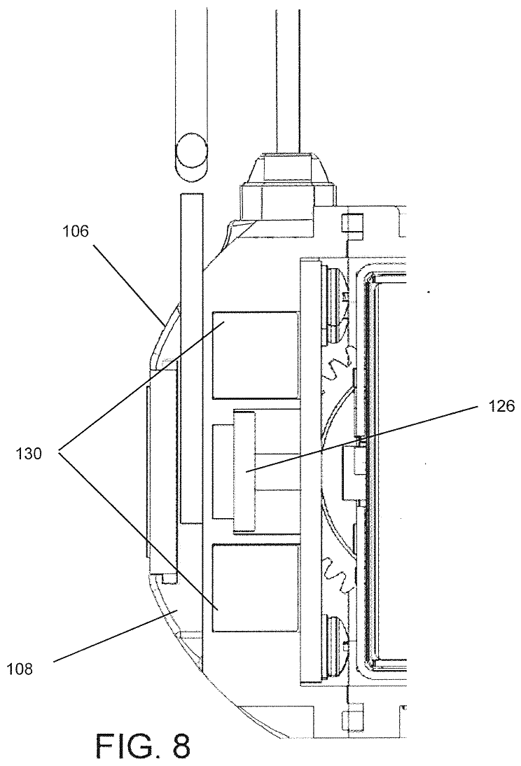

Referring to FIGS. 6A through 10B, in embodiments, the surveillance robot 100 comprises a first magnet 130 and a second magnet 130 disposed inside the housing cavity 108. The magnets 130 may provide a magnetic flux field. Each magnet 130 may be located near the key holding slot 118 with a wall portion of the housing 106 extending between each magnet 130 and the key holding slot 118. The surveillance robot 100 may also comprise a key member 120 conforming to the key holding slot 118. In embodiments, the key member 120 comprises a material with a relative electromagnetic permeability greater than 500 so that the magnetic flux field produced by the magnets 130 changes when the key member 120 is disposed in the key holding slot 118. In embodiments, the magnets 130 produce a first, undeformed magnetic field 122 while the key member 120 is disposed in the key holding slot 118 and the magnets 130 produce a second, deformed magnetic field 124 while the key member 120 is not disposed in the key holding slot 118.

Referring to FIGS. 6A, 8, 12A, and 12B, in embodiments, the surveillance robot 100 comprises a magnetic field sensor 126 disposed inside the housing cavity 108. The magnetic field sensor 126 may be, for example, positioned between the first magnet 130 and the second magnet 130. In embodiments, the magnetic field sensor 126 provides a first output signal when the first, undeformed magnetic field 122 is present and a second output signal when the second, deformed magnetic field 124 is present. In some embodiments, the first output signal is a logical one and the second output signal is a logical zero. In other embodiments, the first output signal is a logical zero and the second output signal is a logical one. In embodiments, the housing 106 includes a wall portion separating the key holding slot 118 from the housing cavity 108. In embodiments, each magnet 130 is located near the key holding slot 118 with the wall portion of the housing 106 extending between each magnet 130 and the key holding slot 118.

Referring to FIGS. 6A, 8, 10A, and 10B, the magnetic field sensor 126 may comprise, for example, a Hall effect sensor 128. In embodiments, the presence of the key member 120 in the key holding slot 118 defined by the key holding portion 116 alters a magnitude of the magnetic field produced by the magnets 130 at the magnetic field sensor 126. For example, the magnetic field produced by the magnets 130 may have a first magnitude at the magnetic field sensor 126 while the key member 120 is present in the key holding slot 118 and a second magnitude at the magnetic field sensor 126 while the key member 120 is absent from the key holding slot 118. In embodiments, the presence of the key member 120 in the key holding slot 118 defined by the key holding portion 116 alters an angle of flux lines in the magnetic field produced by the magnets 130 at the magnetic field sensor 126. For example, the flux lines in the magnetic field produced by the magnets 130 may have a first angle at the magnetic field sensor 126 while the key member 120 is present in the key holding slot 118 and a second angle at the magnetic field sensor 126 while the key member 120 is absent from the key holding slot 118.

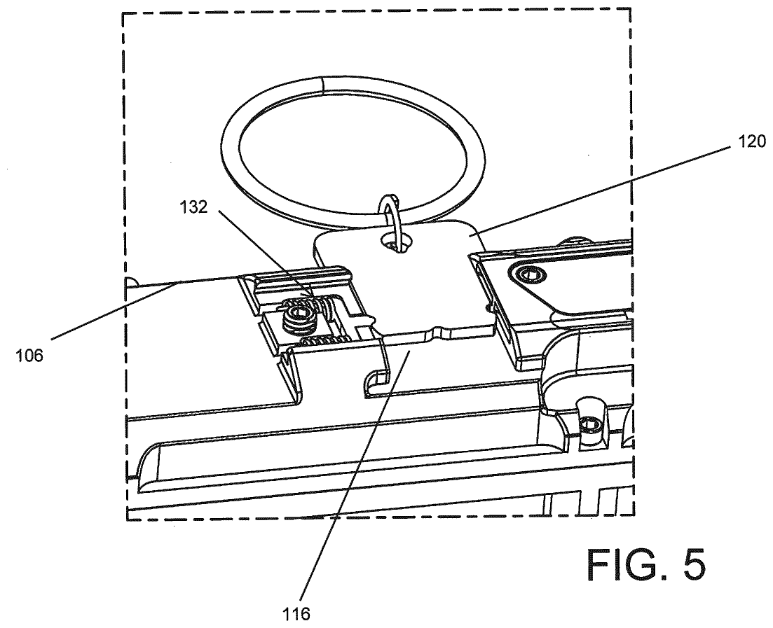

Referring to FIGS. 5, 6A, 6B, and 7, in embodiments, the throwable surveillance robot comprises a key retention mechanism 132 comprising a key engaging element 134 that is slidingly supported by the housing and one or more coil springs 136 that bias the key engaging element 134 toward the key member. In embodiments, the key member defines a notch 138 that is positioned and dimensioned to receive a distal portion of the key engaging element 134.

Referring to FIGS. 1 and 2, a forward direction Z and a rearward direction-Z are illustrated using arrows labeled “Z” and “−Z,” respectively. A port direction X and a starboard direction-X are illustrated using arrows labeled “X” and “−X,” respectively. An upward direction Y and a downward direction-Y are illustrated using arrows labeled “Y” and “−Y,” respectively. The directions illustrated using these arrows may be conceptualized, by way of example and not limitation, from the point of view of a viewer looking through the camera of the robot. The directions illustrated using these arrows may be applied to the apparatus shown and discussed throughout this application. The port direction may also be referred to as the portward direction. In one or more embodiments, the upward direction is generally opposite the downward direction. In one or more embodiments, the upward direction and the downward direction are both generally orthogonal to the ZX plane defined by the forward direction and the starboard direction. In one or more embodiments, the forward direction is generally opposite the rearward direction. In one or more embodiments, the forward direction and the rearward direction are both generally orthogonal to the XY plane defined by the upward direction and the starboard direction. In one or more embodiments, the starboard direction is generally opposite the port direction. In one or more embodiments, the starboard direction and the port direction are both generally orthogonal to the ZY plane defined by the upward direction and the forward direction. Various direction-indicating terms are used herein as a convenient way to discuss the objects shown in the figures. It will be appreciated that many direction indicating terms are related to the instant orientation of the object being described. It will also be appreciated that the objects described herein may assume various orientations without deviating from the spirit and scope of this detailed description. Accordingly, direction-indicating terms such as “upwardly,” “downwardly,” “forwardly,” “backwardly,” “portwardly,” and “starboardly,” should not be interpreted to limit the scope of the invention recited in the attached claims.

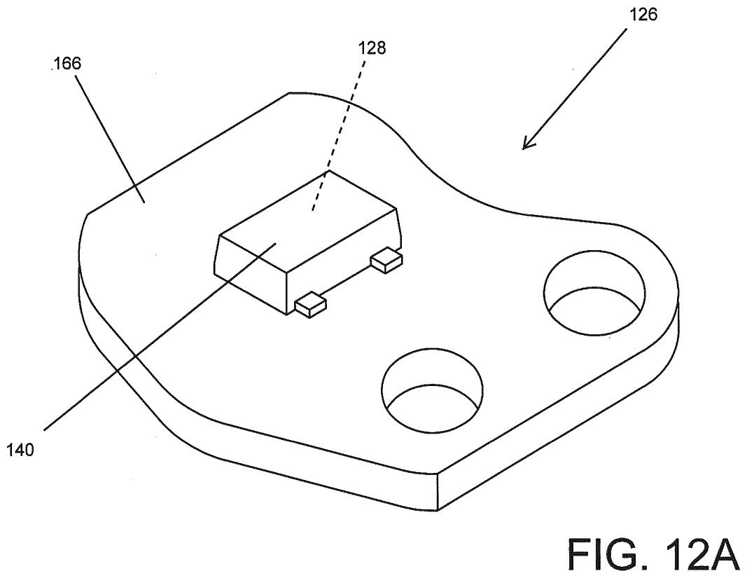

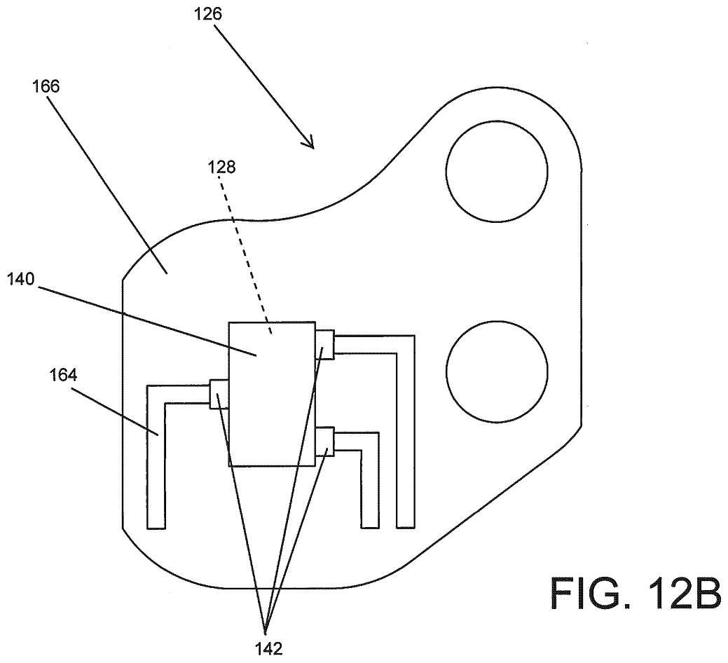

Referring to FIG. 12A and FIG. 12B, a printed wiring board 166 supporting circuitry 164 is shown. FIG. 12A and FIG. 12B may be collectively referred to as FIG. 12. In the embodiment of FIG. 12, the printed wiring board 166 comprises a substrate and the substrate supports a plurality of conductive paths 168 of the circuitry 164. In the example embodiment shown in FIG. 12, the circuitry 164 comprises the printed wiring board 166 and a plurality of electronic components 172 that are electrically connected to the conductive paths of the printed wiring board 166. The plurality of electronic components 172 are mechanically fixed and/or electrically connected to the printed wiring board 166 to form a circuit card assembly 170. In the embodiments of FIG. 12, the circuitry 164 includes a Hall effect sensor 128. In the embodiment of FIG. 12, the Hall effect sensor 128 comprises a semiconductor chip (not shown) disposed inside a casing 140. In the embodiment of FIG. 12, the Hall effect sensor 128 comprises three terminals 142.

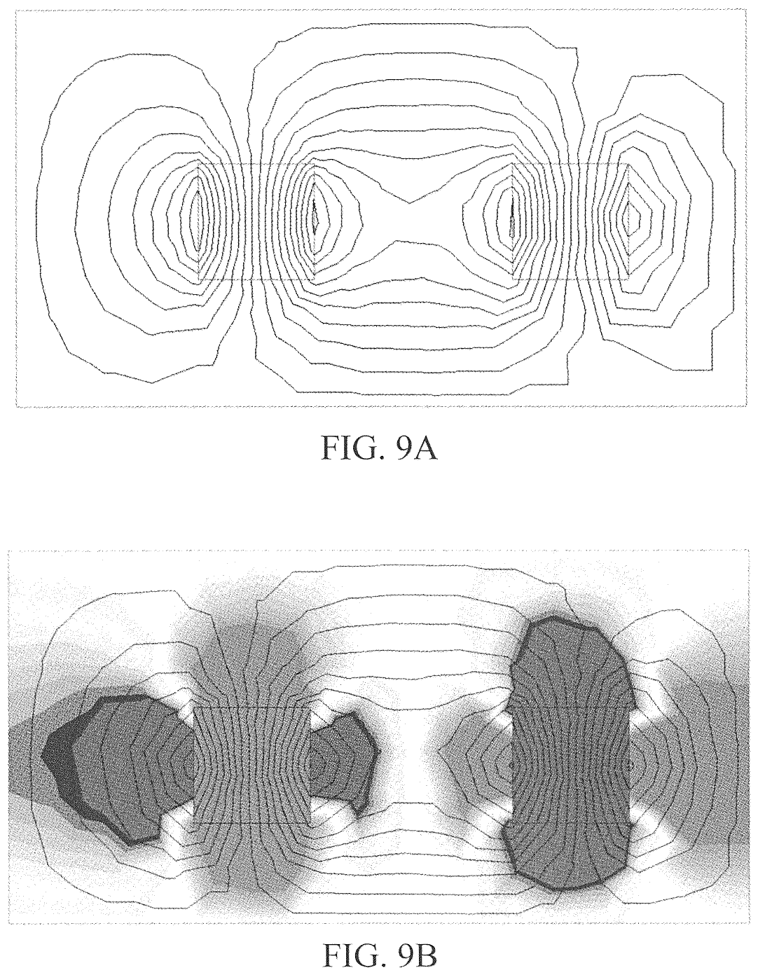

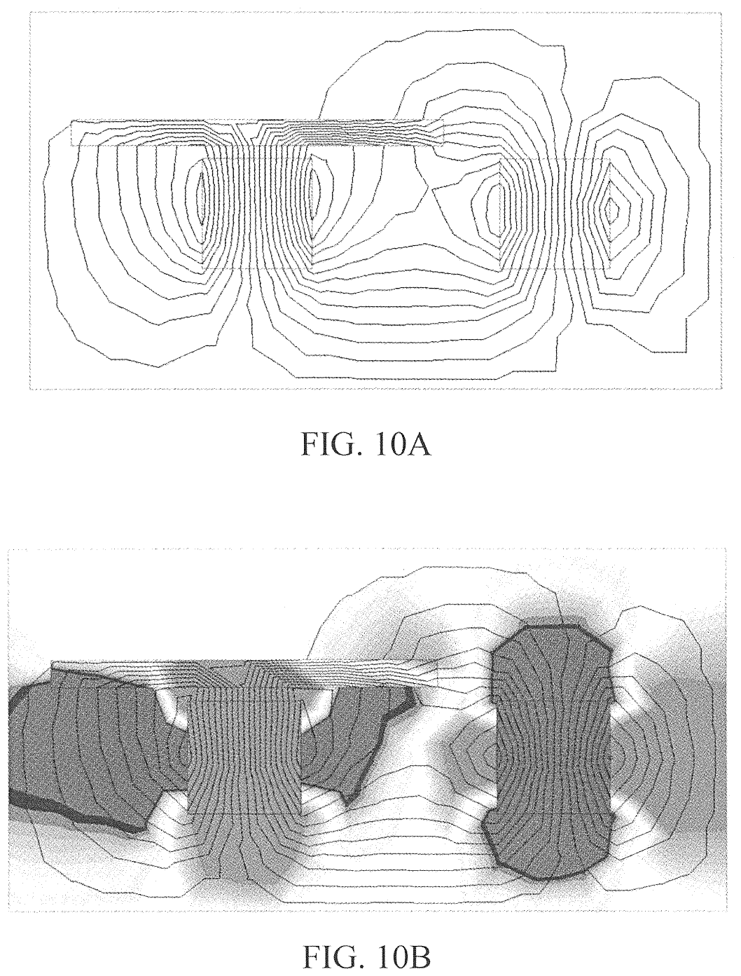

In embodiments, two magnets are spaced some distance apart horizontally at a common elevation, with magnetic fields oriented vertically and with opposite polarities. Their locations are constrained by a non-ferromagnetic material which does not appreciably affect the resulting magnetic field relative to free space. Viewed from the side, the field lines representing the resulting magnetic field between the magnets forms a roughly elliptical shape, with a magnetic field strength at the very center of the distance between the magnets of ideally zero. In embodiments, a vertically-polarized magnetic sensor is placed midway between the two magnets, coplanar or slightly lower than coplanar with the tops of the magnets. This sensor may have a digital output that trips at a certain vertical magnetic field strength, and releases at a second vertical magnetic field strength. In embodiments, the sensor is not tripped due to the very low (near zero) vertical field strength where the sensor is located. Referring to FIG. 9A and FIG. 9B, two illustrations of magnetic field lines are shown. The black-and-white illustration shows magnetic field lines, and the color illustration shows the strength of the vertical component of the magnetic field (red is one polarity, purple is the opposite polarity, and yellow is a bin near zero). Referring to FIG. 10A and FIG. 10B, two illustrations of magnetic field lines are shown. FIG. 10A and FIG. 10B are similar to FIG. 9A and FIG. 9B, but with a plate made of ferromagnetic material (e.g., steel) placed near the tops of the magnets (e.g., on the other side of an outer wall of the device, e.g., 0.030″ away). This plate or key member it placed such that it completely covers one magnet and the sensor, but does not extend over the second magnet. Due to the symmetry of the construction, the system could function regardless of which magnet is covered. The plate or key member disturbs the symmetry of the first configuration, resulting in a warped magnetic field. The resulting field has a substantially vertical component in the center of the system, where the magnetic field sensor is. This disturbance is of a large enough magnitude for the magnetic field sensor to detect its presence.

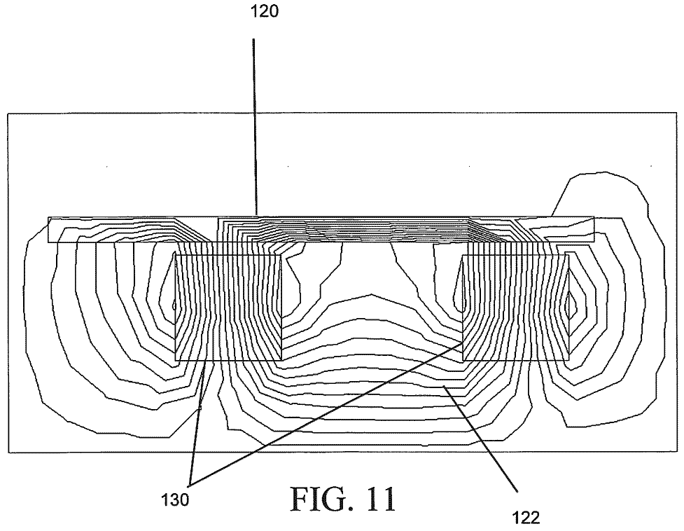

Referring to FIG. 11, another embodiment includes a plate or key member extending over two magnets and the magnetic field sensor. This restores symmetry to the magnetic field, and the sensor releases or does not trip due to the low field strength detected.

Because the sensor only trips in the second configuration, the surrounding structure of the device and the plate or key member can be constructed so as to reliably put the plate or key member at the correct location to detect it. In embodiments, a non-authorized user may have difficulty tripping the sensor, without the plate or key member. In embodiments, the sensor may not be tripped with a piece of ferromagnetic material, because the system is sensitive to the specific location and orientation of the plate or key member. In this way, the system can be used as a tamper-resistant means to turn a device on or off.

In embodiments, the two magnets may be, for instance, grade N52 Neodymium-Iron-Boron cylindrical magnets, with a diameter of ¼″ and height of ¼″. In embodiments, the field strength at the sensor location may be 2 mT without the plate or key member in place, and 100 mT with the plate or key member in place. In embodiments, the magnetic field sensor comprises a hall-effect type sensor with a typical trip point of 60 mT and a typical release point of 45 mT. Examples of hall-effect sensors that may be suitable in some applications include the Honeywell SL353LT hall-effect sensor. In embodiments, the housing wall thickness may be 0.030 inch. In embodiments, the plate or key member may be on the order of 1/16 inch thick. In embodiments, spacing between the magnets may be 0.700 inch center-to-center. Because of the symmetrical construction of the system, there may be wide latitude in selecting magnet strength and spacing. In embodiments, the above parameters may vary ±50%. In embodiments, the above parameters may vary by −60% and ±150%.

An example alternate arrangement could include a single magnet, with the sensor placed at a specific distance from the magnet. This arrangement would rely on the exact strength of the magnetic field and the trip and release points of the sensors (the two-magnet design uses symmetry to be more robust to these factors). As a result, tolerances for the magnet, sensor, and relative placement of the elements would be important to the successful operation. This arrangement would not possess the tamper-resistant characteristics that arise from embodiments described above.

Note that the description herein refers to horizontal/vertical orientations for the sake of orienting components with respect to one another, but this does not restrict function of this system (e.g., the whole system could be rotated through an arbitrary angle along any axis and still function).

In embodiments, the plate or key member is retained in place by the magnetic force of the magnets. In an embodiment, the plate slides into a slot, the slot constraining the key member. The key member in the slot may be further retained by magnetic force from the one or more magnets.

In embodiments, the robot may include a plate extending across the two magnets, on the side of the magnets opposite the key member. The plate may comprise a material with an electromagnetic permeability that allows magnetic flux lines to flow through the plate. The use of this plate may allow the two magnets to be shorter (relative to an arrangement without the plate). The shorter magnets may facilitate a thinner total thickness for the arrangement including the two magnets, the plate, the sensor and the key member.

In embodiments the robot wheels are less than 6 inches in diameter. In embodiments, less than 5 inches. In embodiments, less than 4 inches. In embodiments, the robot weighs less than 5 pounds.

In embodiments, the robot may have different operational states or “modes.” For example, a robot may have a sleep mode where the robot is able to conserve battery, for example by placing some systems or components in a low power state, without being fully offline. A sleep mode allows the robot to boot, that is to enter a fully operational state, faster than booting from a fully offline mode. In situations where rapid robot deployment is required, any reduction in boot times becomes important to a successful mission. In some scenarios, it may also be preferable to store the robot in a sleep mode instead of an offline mode.

In embodiments, the magnetic field sensor may be employed to set the robot into various operational states or modes. For example, the magnetic hall sensor may have multiple trip points, where each trip point is associated with an operational state. In another example, the robot may have multiple sensors, each sensor configured with a trip point. In yet another example, the robot might detect different shapes of the magnetic field, where each shape is associated with an operational state or mode. In such embodiments, the robot may include multiple keys such that the insertion (or removal) of a particular key triggers a particular mode. For example, a first key may be used to place the robot in an offline mode, whereas a different, second key places the robot into a sleep mode. Different keys may be formed of different materials or different shapes to create the intended effect on the strength and/or shape of the magnetic field, thereby placing the robot into the desired mode. Combinations of different materials and shapes may also be used. In embodiments, combinations of shapes and materials allows for more key and mode combinations.

In embodiments, a robot may have a quick boot configuration allowing for faster boot times. For example, a lack of retention force, or a reduction in retention force, of the key may allow the robot to power cycle. In embodiments, a robot in a quick boot or quick power cycle configuration may forgo the detent retention features of the key, allowing the key to be more quickly inserted and/or removed from the robot. In some embodiments, the quick boot configuration may be achieved by modifying the key retention mechanism to provide minimal or zero retention force when the key member is inserted into the key holding slot. The reduced retention force may allow for rapid insertion and withdrawal of the key member without requiring significant manual force or time-consuming engagement procedures. In embodiments, the key member may be designed with a smooth profile that lacks mechanical detents, grooves, or other retention features that would otherwise require additional force or time to engage or disengage. In embodiments, the quick boot configuration may utilize a magnetic retention system where the magnetic force between the magnets and the key member provides sufficient retention for operational purposes while allowing for rapid removal when needed. The magnetic retention force may be calibrated to maintain the key member in position during normal operation while permitting quick extraction during emergency or rapid deployment scenarios. In embodiments, the robot may include multiple key holding slots, where one slot is configured for standard operation with full retention features, and another slot is configured for quick boot operation with reduced or eliminated retention features. This dual-slot configuration may allow operators to select between secure, long-term operation and rapid deployment modes based on mission requirements. In embodiments, the quick boot configuration may incorporate a spring-loaded mechanism that automatically ejects the key member after a predetermined time period, forcing the robot to power cycle and restart. This automatic ejection feature may ensure that the robot does not remain in an intermediate state for extended periods, which could compromise battery life or operational readiness. In embodiments, the key member used in quick boot configurations may have a different material composition or thickness compared to standard key members, allowing for optimized magnetic field interaction while maintaining the reduced retention characteristics. A quick boot key member may be designed with chamfered edges or rounded corners to facilitate smooth insertion and removal from the key holding slot. In embodiments, the robot's control circuitry may be configured to recognize when a quick boot key member is inserted and automatically adjust boot sequences, power management protocols, or operational parameters to accommodate the rapid cycling requirements. The robot may store configuration data in non-volatile memory to maintain settings between quick boot cycles, reducing the time required for system initialization.

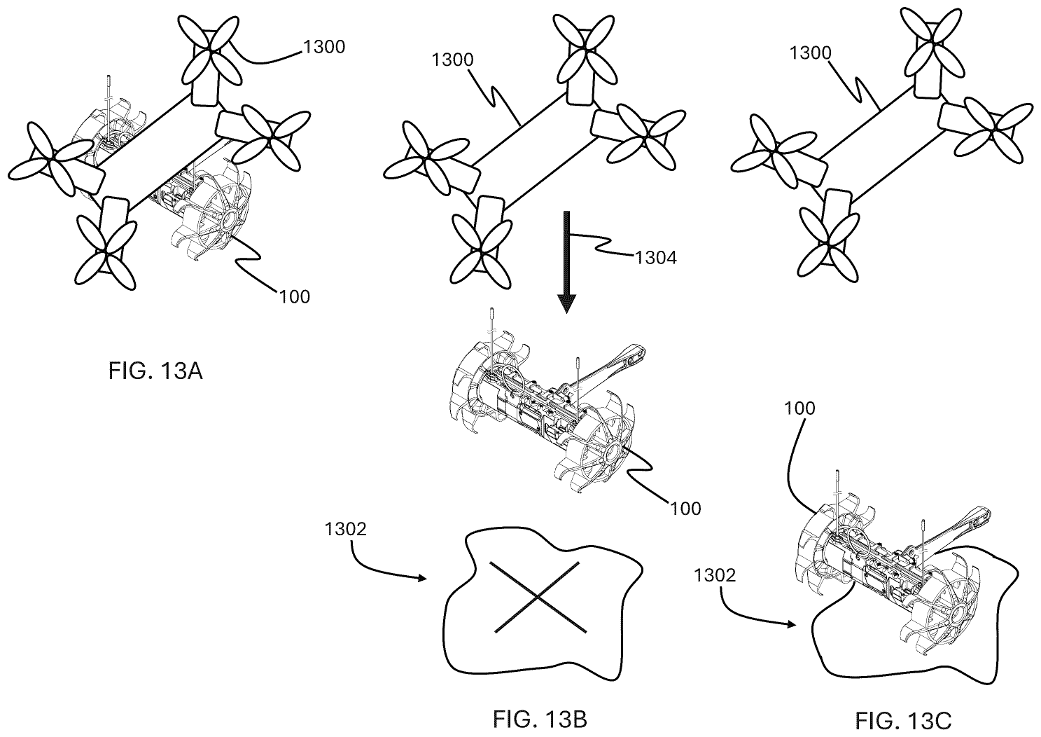

In embodiments, a robot may include quick release or activation features. In embodiments, a robot may include automated activation features. Referring to FIGS. 13A-C, quick release and/or automated features may be useful for remote deployment of a robot 100 from an Unmanned Aircraft System (UAS), Unmanned Aerial Vehicle (UAV), drone 1300, or the like. A UAS or UAV 1300 may carry a robot 100 to a deployment site 1302 and drop it from the air. In embodiments, the force generated 1304 from the falling robot may be used to activate the robot 100. In embodiments, an automated system, such as an altimeter, may be used as a trigger to activate the robot. In embodiments, a GPS or similar location system could automatically activate the robot 100 when the robot 100 is within a certain range of a deployment zone 1302.

In embodiments, the drone 1300 may include a release mechanism that secures the robot 100 during transport and releases the robot 100 at the appropriate deployment location. The release mechanism may comprise electromagnetic clamps, mechanical latches, or spring-loaded ejection systems that can be remotely triggered by the drone operator or activated automatically based on predetermined criteria such as GPS coordinates, altitude, or mission timing.

In embodiments, the robot 100 may include impact-activated switches or sensors that detect the force 1304 generated during landing at the deployment site 1302. These impact sensors may comprise accelerometers, piezoelectric elements, or mechanical switches that respond to the deceleration forces experienced when the robot 100 contacts the ground. The impact activation system may be calibrated to distinguish between normal handling forces and actual deployment impacts, preventing inadvertent activation during transport or minor disturbances.

In embodiments, the altimeter-based activation system may utilize barometric pressure sensors, radar altimeters, laser rangefinders, or the like, to determine the robot's altitude above the deployment site 1302. The activation system may be programmed with specific altitude thresholds that trigger different operational modes, such as a pre-activation mode at a higher altitude to prepare systems for deployment, and full activation at a lower altitude just before landing.

In embodiments, the GPS-based activation system may incorporate geofencing technology that defines virtual boundaries around the deployment zone 1302. The robot 100 may remain in a dormant or low-power state until the GPS receiver detects entry into the predefined geographic area. The GPS activation system may also include backup positioning methods such as GLONASS, Galileo, or inertial navigation systems to ensure reliable position determination in challenging environments.

In embodiments, the automated activation features may include time-delay mechanisms that activate the robot 100 after a predetermined period following deployment. This time-delay activation may allow the drone 1300 to safely exit the area before the robot 100 becomes operational, reducing the risk of interference or detection.

In embodiments, the robot 100 may include multiple activation triggers that work in combination, such as requiring both GPS proximity to the deployment zone 1302 and impact detection to fully activate the system. This multi-factor activation approach may enhance security and prevent accidental activation while ensuring reliable deployment when intended.

In embodiments, the drone 1300 may transmit activation signals to the robot 100 during or after deployment, using radio frequency, infrared, or acoustic communication methods. The activation signal may include encrypted commands or authentication codes to prevent unauthorized activation by hostile forces.

In embodiments, the robot 100 may include environmental sensors that contribute to the activation decision, such as light sensors that detect day/night conditions, temperature sensors that confirm outdoor deployment, or acoustic sensors that detect specific sound signatures associated with the intended deployment environment.

In embodiments, the quick release features may include breakaway tethers or frangible connections between the drone 1300 and robot 100 that separate cleanly during deployment without damaging either system. These connections may be designed to withstand transport forces while reliably separating under deployment conditions.

In embodiments, the robot 100 may include a deployment parachute or other drag-reducing mechanism that deploys automatically after release from the drone 1300, controlling the descent rate and impact forces at the deployment site 1302. The parachute system may include altitude-activated deployment mechanisms and may be designed to separate from the robot 100 after landing to avoid interference with subsequent operations.

The following clauses illustrate the subject matter described herein.

Clause 1: A throwable surveillance robot comprising a pair of axially aligned drive wheels, each wheel having a maximum diameter; a body, the body comprising a housing extending between the drive wheels, the housing being disposed within a cylinder defined by the maximum diameters of the drive wheels, the housing defining a housing cavity, the housing including a key holding portion defining a key holding slot, the key holding slot having a key member insertion and withdrawal axis; a magnet disposed inside the housing cavity, the magnet being located near the key holding slot; a magnetic field sensor disposed inside the housing cavity, the magnetic field sensor providing a first output signal when a first key member is present a second output signal when a second key member is present.

Clause 2: The throwable surveillance robot of clause 1, wherein the first and second key members comprise different materials.

Clause 3: The throwable surveillance robot of any of the above clauses, wherein the first and second key members comprise different shapes.

Clause 4: The throwable surveillance robot any of the above clauses, wherein the first key member has a first effect on the magnetic field and the second key member has a second effect on the magnetic field.

Clause 5: The throwable surveillance robot of any of the above clauses, wherein the first and second output signals are associated with an operational state of the robot. Clause 6: The throwable surveillance robot of clause 5, wherein the operational state is one of off, on, or sleep.

Clause 7: The throwable surveillance robot of clause 6, wherein the sleep state is a low power consumption mode.

Clause 8: The throwable surveillance robot of any of the above clauses, wherein the presence of the first or second key member in the key holding slot defined by the key member receiving structure alters a strength of the magnetic field produced by the magnet at the magnetic field sensor, the magnetic field produced by the magnet having a first strength at the magnetic field sensor when the first key member is present in the key holding slot and a second strength at the magnetic field sensor when the second key member is present in the key holding slot.

Clause 9: The throwable surveillance robot of any of the above clauses, wherein the presence of the key member in the key holding slot defined by the key member receiving structure alters an angle of flux lines in the magnetic field produced by the magnet at the magnetic field sensor, the flux lines in the magnetic field produced by the magnet having a first angle at the magnetic field sensor when the first key member is present in the key holding slot and a second angle at the magnetic field sensor when the second key member is present in the key holding slot.

Clause 10: The throwable surveillance robot of any of the above clauses, wherein the magnetic field sensor comprises a Hall effect sensor.

Clause 11: The throwable surveillance robot of any of the above clauses, wherein the key member is configured as a plate.

Clause 12: The throwable surveillance robot of any of the above clauses, wherein the key member is configured as a plate with opposing planar sides, each opposing planar side having a rectangular shape.

Clause 13: The throwable surveillance robot of any of the above clauses, wherein the key member has a parallelepiped three dimensional shape.

Clause 14: The throwable surveillance robot of any of the above clauses, wherein the housing includes a wall portion separating the key holding slot from the magnet.

Clause 15: The throwable surveillance robot of any of the above clauses, further comprising a key retention mechanism comprising a key engaging element that is slidingly supported by the housing and a coil spring that biases the key engaging element toward the key member.

Clause 16: The throwable surveillance robot of clause 15, wherein the key member defines a notch that is positioned and dimensioned to receive a distal portion of the key engaging element.

Clause 17: A throwable remotely controlled robot comprising: a housing; a magnet disposed inside the housing, the magnet generating a magnetic field; an enable/disable sensor disposed inside the housing, the sensor being positioned a distance from the magnet, the sensor providing a first output signal when a first-magnetic field is present and a second output signal when a second magnetic field is present; and a first key member formed of a material to modify the magnetic field, the modified magnetic field being associated with an operational mode, wherein the throwable remotely controlled robot has a total weight of less than six pounds.

Clause 18: The throwable remotely controlled robot of clause 17, wherein the total weight of the robot places the robot in an activated mode when falling from a height of greater than 10 feet.

Clause 19, The throwable remotely controlled robot of clause 17 or 18, wherein the robot is configured to be carried in the air by a drone.

Clause 20: The throwable remotely controlled robot of clause 19, where the drone is configured to drop the drone at a deployment site.

Clause 21: The robot of any of clauses 17-19, wherein the first key member is made of steel.

Clause 22, The robot of any of clauses 17-21, wherein the housing includes a key holding portion defining a key holding slot.

Clause 23: The robot of clause 22, wherein the first key member has a shape conforming to the key holding slot.

Clause 24: The robot of clause 23, wherein the first key member does not have a detent such that the robot has a reduced power cycle time.

Clause 25: A throwable remotely controlled robot with a housing an enable/disable sensor comprising a magnet generating a magnetic field, and a sensor positioned in proximity, the sensor requiring a specific modification of the magnetic field to actuate the sensor, and further comprising a first key plate formed of a material to modify the magnetic field to set a first mode of the robot, wherein the first key plate is retained within the housing by a magnetic force.

Clause 26: The throwable remotely controlled robot of clause 25, further comprising a second key plate formed of a material to modify the magnetic field to set a second mode of the robot, wherein the second key plate is retained within the housing by a magnetic force.

Clause 27: The throwable remotely controlled robot of clause 26, wherein the housing comprises a slot configured to retain each of the first key plate and the second key plate.

Clause 28: The throwable remotely controlled robot of clause 26 or clause 27, wherein the specific modification of the magnetic field is an increased vertical component of the magnetic field as measured by the sensor.

Clause 29: The throwable remotely controlled robot of any of clauses 26-28, wherein a vertical component of the magnetic field is associated with the first or second mode.

The following United States patents are hereby incorporated by reference herein: U.S. Pat. Nos. 10,046,819, 9,061,544, 6,548,982, 6,502,657, U.S. D637217, and U.S. D626577. Components illustrated in such patents may be utilized with embodiments herein. Incorporation by reference is discussed, for example, in MPEP section 2163.07(B).

The patents and other references mentioned above in all sections of this application are herein incorporated by reference in their entirety for all purposes.

All of the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive.

Each feature disclosed in this specification (including references incorporated by reference, any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed. The above references in all sections of this application are herein incorporated by references in their entirety for all purposes.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

What is claimed is:

1. A throwable surveillance robot comprising:
a pair of axially aligned drive wheels, each wheel having a maximum diameter;
a body, the body comprising a housing extending between the drive wheels, the housing being disposed within a cylinder defined by the maximum diameters of the drive wheels, the housing defining a housing cavity, the housing including a key holding portion defining a key holding slot, the key holding slot having a key member insertion and withdrawal axis;
a magnet disposed inside the housing cavity, the magnet being located near the key holding slot;
a magnetic field sensor disposed inside the housing cavity, the magnetic field sensor providing a first output signal when a first key member is present a second output signal when a second key member is present.

2. The throwable surveillance robot of claim 1, wherein the first and second key members comprise different materials.

3. The throwable surveillance robot of claim 1, wherein the first and second key members comprise different shapes.

4. The throwable surveillance robot of claim 1, the first key member has a first effect on the magnetic field and the second key member has a second effect on the magnetic field.

5. The throwable surveillance robot of claim 1, wherein the first and second output signals are associated with an operational state of the robot.

6. The throwable surveillance robot of claim 5, wherein the operational state is one of off, on, or sleep.

7. The throwable surveillance robot of claim 6, wherein the sleep state is a low power consumption mode.

8. The throwable surveillance robot of claim 1 wherein the presence of the first or second key member in the key holding slot defined by the key member receiving structure alters a strength of the magnetic field produced by the magnet at the magnetic field sensor, the magnetic field produced by the magnet having a first strength at the magnetic field sensor when the first key member is present in the key holding slot and a second strength at the magnetic field sensor when the second key member is present in the key holding slot.

9. The throwable surveillance robot of claim 1 wherein the presence of the key member in the key holding slot defined by the key member receiving structure alters an angle of flux lines in the magnetic field produced by the magnet at the magnetic field sensor, the flux lines in the magnetic field produced by the magnet having a first angle at the magnetic field sensor when the first key member is present in the key holding slot and a second angle at the magnetic field sensor when the second key member is present in the key holding slot.

10. A throwable remotely controlled robot comprising:
a housing;
a magnet disposed inside the housing, the magnet generating a magnetic field;
an enable/disable sensor disposed inside the housing, the sensor being positioned a distance from the magnet, the sensor providing a first output signal when a first-magnetic field is present and a second output signal when a second magnetic field is present; and
a first key member formed of a material to modify the magnetic field, the modified magnetic field being associated with an operational mode,
wherein the throwable remotely controlled robot has a total weight of less than six pounds.

11. The throwable remotely controlled robot of claim 10, wherein the total weight of the robot places the robot in an activated mode when falling from a height of greater than 10 feet.

12. The throwable remotely controlled robot of claim 10, wherein the robot is configured to be carried in the air by a drone.

13. The throwable remotely controlled robot of claim 12, where the drone is configured to drop the robot at a deployment site. 14 The robot of claim 10, wherein the housing includes a key holding portion defining a key holding slot, and wherein the first key member has a shape conforming to the key holding slot.

15. The robot of claim 14, wherein the first key member does not have a detent such that the robot has a reduced power cycle time.

16. A throwable remotely controlled robot with a housing an enable/disable sensor comprising a magnet generating a magnetic field, and a sensor positioned in proximity to the magnet, the sensor requiring a specific modification of the magnetic field to actuate the sensor, and further comprising a first key plate formed of a material to modify the magnetic field to set a first mode of the robot, wherein the first key plate is retained within the housing by a magnetic force.

17. The throwable remotely controlled robot of claim 16, further comprising a second key plate formed of a material to modify the magnetic field to set a second mode of the robot, wherein the second key plate is retained within the housing by a magnetic force.

18. The throwable remotely controlled robot of claim 17, wherein the housing comprises a slot configured to retain each of the first key plate and the second key plate.

19. The throwable remotely controlled robot of claim 17, wherein the specific modification of the magnetic field is an increased vertical component of the magnetic field as measured by the sensor.

20. The throwable remotely controlled robot of claim 17, wherein a vertical component of the magnetic field is associated with the first or second mode.
